(19) United States
(12) Patent Application Publication
(10) Pub. No.: US 2006/0098235 A1
(43) Pub. Date: May 11, 2006

(54) Method of producing an image on a printing screen

(75) Inventors: Orson L. Bourne, Cumberland (CA); Keith Ingold, Gloucester (CA); David Kennedy, Ottawa (CA); Gunnar P. Wareberg, Cumberland (CA); David Girard, Kanata (CA); Gary Baxter, Vankleek Hill (CA); Brian Baxter, Morrisburg (CA)

Correspondence Address: MARKS & CLERK, P.O. BOX 957, STATION B, OTTAWA, ON, K1P 5S7, CA

(73) Assignee: National Research Council of Canada, Ottawa (CA)

(21) Appl. No.: 10/533,305

(22) PCT Filed: Oct. 29, 2003
(86) PCT No.: PCT/CA03/01643

§ 371 Date: Oct. 31, 2005

Related U.S. Application Data
(60) Provisional application No. 60/422,175, filed on Oct. 30, 2002.

(51) Int. Cl. B41C 1/04

(52) U.S. Cl. 358/3.29

(57) ABSTRACT

Methods of producing an image on a printing screen are described. The method uses inkjet printing technology to form an image on the screen using a computer to screen or computer to plate imaging technique. According to particular embodiments a specially formulated emulsion is used in which the emulsion is mixed with a cross-linking agent to create a self curing image.

This application claims benefit of U.S. Provisional Application No. 60/422,175 filed Oct. 30, 2002.

### FIELD OF THE INVENTION

This invention relates to a computer-to-screen (CTS) imaging system and more particularly to systems and methods for reproducing a digitized image on a silk screen stencil or lithography plate.

### BACKGROUND

In certain printing processes, such as screen printing, a stencil containing, for example, a negative of a desired image is required. In the printing process this stencil is placed on the surface of the carrier to which the image is to be transferred and ink is imprinted through the stencil.

There are numerous existing techniques for preparing the stencil with one of the most common involving the use of a photographically prepared negative which is placed over a screen onto which has been applied a photo activatable emulsion. Such emulsions are typically sensitive to ultraviolet radiation and in this process the screen is exposed to ultraviolet radiation such that the portions of the screen not blocked by the photographic mask are activated. Typically the emulsion is water soluble or at least soluble in a known solvent and in the developing process the non-activated emulsion is removed from the screen thereby leaving a negative of the image. It will be apparent to one skilled in the art that the process can be used to generate a positive of the image.

With ongoing advances in digitized images it is particularly advantageous to directly convert an image from a computer to the stencil. Several methods of performing this conversion have been developed in as much as computer to screen imaging is seen as a method of allowing an operator to modify images or to prepare images based on drawings or other two dimensional formats utilizing a scanning application. Recent improvements in the work flow associated with the actual printing process and the use of digital imaging in the preparation of graphics has made the need for a true CTS an important enabler in order to realise cost benefits produced by other technological improvements.

The prior art includes numerous methods of preparing stencils using a CTS imaging process. These include a laser ablation system in which a laser is used to remove material from a fully blocked screen with the non-removed material creating the negative image.

It is also known to use laser direct imaging in which a laser is scanned point by point over a silk screen coated with a photo activated emulsion to create an image in that emulsion.

Another known method is an optical micro electrical mechanical system (MEMS) technique wherein a series of independently controllable mirrors are used to direct light onto a clearly defined and limited area of a screen which has been coated with a photo-activatable emulsion. Once this area has been activated the mirrors are directed to an adjacent block of the screen and the process repeated. In this manner a full image can be constructed block by block.

U.S. Pat. No. 5,580,698, which issued Dec. 3, 1996 to Anderson, describes a system for producing fine printing patterns on large serigraphical printing frames utilising a type of mirror arrangement. In this patent a laser beam is directed through a series of mirrors to a scanner which is moved laterally and longitudinally along sections of a screen and the light source is modulated in order to produce a pattern. The light source is a ultraviolet laser and the pattern is generated in a dot by dot sequence.

In U.S. Pat. No. 6,178,006 a system for plotting a computer stored raster image on a plain photosensitive record carrier is discussed. In this patent the area to be prepared is subdivided into numerous sub areas and each one is processed sequentially.

Each one of these known methods has a number of serious limitations. For example, debris re-deposition is an issue with the laser ablation and like the laser direct image method it is a point by point process. This limits the exposure rate of both methods. Mechanical instability and reliability will be inherent issues with the MEMS method. In fact, this will be true for any projection method.

Ink jet masking represents another body of prior art relating to stencil formation. In one example of this technique a negative of the image to be printed is created by using an ink jet to deposit wax onto a screen coated with a photo activatable emulsion. The deposited wax blocks the light when the screen is subsequently exposed. Once exposure is completed the wax is removed to produce the final printable image. An example of an ink jet masking approach is disclosed in U.S. Pat. No. 5,875,712 which issued Mar. 2, 1999 to Ericsson et al. In the Ericsson et al. patent, carbon powder is selectively deposited using a printer unit where the carbon powder prevents light from reaching the screen and, after the exposure step, subsequent rinsing removes all of the unexposed material.

Canadian Patent 2088400 which issued Jan. 23, 1994 to Gerber Scientific Products, Inc. also teaches the use of an inkjet to deposit a blocking agent onto a screen mesh to produce a stencil. Canadian Patent 2088400 can not be applied to an inkjet process if a typical emulsion is used as the blocking agent. A screen emulsion can have a viscosity of over 10,000 cps and up to 65% of its volume can be made up of solid particles (fillers). The purpose of such solids are two fold, (a) they make the cured emulsion more resilient to the rigors of the printing process and (b) they improve the definition and hence the overall quality of the image. These particles can range in size from 3 to 100 microns and can and do agglomerate into larger partides. A typical ink jet can deposit a fluid if its viscosity is less than 20 cps. Therefore even if the jets could discharge an emulsion with a viscosity of 10,000 cps at the desired resolution, the solids present in the emulsion will quickly plug the jetting nozzles. Hence the inability of CA 02088400.

EP-A-0492351 also to Gerber Scientific Products, Inc. teaches the use of an inkjet to create a light-blocking mask on a screen that had been previously coated with a light sensitive emulsion. On exposure to UV light the areas which are not blocked are rendered insoluble to water as a result of additional cross-linking of the polymer. Subsequent processing according to the known art will produce a stencil. In the case of EP-A-0492351 there is the further requirement to expose the un-masked regions to UV light. This represents an added complexity.

U.S. Pat. No. 5,380,769 which issued Jan. 10, 1995 to Titterington et al. teaches that a chemical deposited by an inkjet can be used instead of UV light to produce additional cross linking. This is simply confirmation of the established knowledge that crosslinking can be driven by a chemical process. In U.S. Pat. No. 5,380,769 a chemical curing agent is applied to a phase-change base ink. The cured region of the ink is then transferred to the image substrate in a secondary process. Any ink in its liquid phase will have a natural tendency to wet beyond the point of contact when deposited onto an absorbing medium. For good image reproduction this tendency must be inhibited. The standard inhibitor method is to use a paper coated with anti-wetting chemicals. The solution that U.S. Pat. No. 5,380,769 teaches relies on the fact that an ink in its solid phase is less mobile than when it is its liquid phase. Therefore, if an ink is used which immediately becomes solid once it is deposited onto an absorbing surface, the tendency for the ink to wet is reduced. This phase transition, liquid to solid, is a physical change. It can be easily reverse and it does not change the chemical nature of the ink, i.e., if the ink is soluble in water before the phase change it will remain soluble in water after the phase change. The advantage of this approach is it allows for the use of a less expensive un-coated paper for the production of high quality colour images. However the requirements of a screen emulsion are fundamentally different.

EP 0909642 published Mar. 12, 2003 to Autotype International Limited teaches that post processing of the finished stencil with aqueous potassium carbonate can increase the durability and resilience of the stencil. However the chemical as used plays no role in the crosslinkng process nor does it improve the image resolution.

In stencil preparation cured emulsion must serve many distinct purposes. It acts as a gasket to inhibit the spread of ink between adjacent regions of the printed surface. It must allow the screen mesh to efficiently transport the ink from its top surface to the substrate. The emulsion must not only evenly wet the surface of the mesh, it must also permeate the complete body of the mesh. An emulsion must be capable of producing an image with good edge definition and this image must be capable of withstanding the physical wear and tear of the screen printing process. These requirements are contrary to the properties of an ink. Therefore the art that is taught in U.S. Pat. No. 5,380,769 is not applicable to a screen emulsion.

Although CA 02088400, EP-A-0492351, U.S. Pat. No. 5,380,769, EP 0909642 in combination teaches the general art of producing a stencil from a digital file but the stencils produced by these methods are generally unsatisfactory. There are many factors that make producing a stencil by this known art challenging. For example CA 02088400 cannot be used with a standard screen emulsion. The phase change as described in U.S. Pat. No. 5,380,769 can only be used to control the resolution of the image but it does not improve the durability of the ink. In the Autotype, International processes (U.S. Pat. No. 6,539,856 B2 and EP 0 909 642 B1) the curing agent induces a chemical phase change but no discussion on its benefits to the resolution or the durability of the final stencil is provided. Also the role of the solid in the curing process is not considered. It is the purpose of this invention to describe how this state of the known art can be improved upon and lead to the production of a stencil which meets industry standards.

### SUMMARY OF THE INVENTION

The present invention seeks to provide a method and apparatus that will reduce the tendency for an inkjet applied curing agent to spread beyond the point of initial contact and thus improve image definition. It is also within the scope of this invention to show how additional solids can be incorporated within the body of the emulsion as it cures using this method and apparatus. It is the further purpose of this invention to show how to use optical curing and chemical curing in combination to rapidly and economically produce a high resolution stencil. It is also a purpose of this invention to provide a method and apparatus to deposit an emulsion with an inkjet. The invention, further seeks to provide a method and apparatus that will incorporate a solid into the body of an emulsion as it cures. It is a further purpose of this invention to provide a method and apparatus that can deposit a self-curing emulsion that manufacturers its own solids within its body.

It is also the purpose of this invention to show how the creation of agents during a curing process can inhibit the diffusion of the curing agent or emulsion.

Accordingly, the present invention provides a simple and efficient method of generating a stencil using a computer to screen imaging system.

Therefore, in accordance with a first aspect of the present invention there is provided a method of producing an image on a printing screen comprising the steps of: coating the printing screen with a water soluble blocking agent; providing a curing agent that can interact with the blocking agent to create insoluble agents; selectively applying the curing agent to the blocking agent in an image wise manner where the image becomes water insoluble; and washing away uncured blocking agent.

In accordance with a second aspect of the invention there is provided a method of producing an image on a printing screen comprising the steps of selectively depositing a diluted and filtered photopolymer emulsion on the printed screen; and curing the selectively deposited image with a curing agent.

According to a third aspect of the invention there is provided a method of producing an image on a printing screen comprising: providing a curing agent that can interact with a blocking agent to create insoluble agents premixing the curing agent with a photopolymer emulsion; and selectively depositing the curing agent and emulsion on said printing screen wherein said emulsion is self curing on placement on the screen.

In accordance with a preferred embodiment of this aspect of the invention the crosslinking agent is deposited using an inkjet printer.

### BRIEF DESCRIPTION OF THE DRAWINGS

The invention will now be described in greater detail with reference to the attached drawings wherein:

FIG. 1 is a inkjet deposit method according to the prior art; and

FIG. 2 shows a cross sectional view of a deposition system according to the invention.

### DETAILED DESCRIPTION

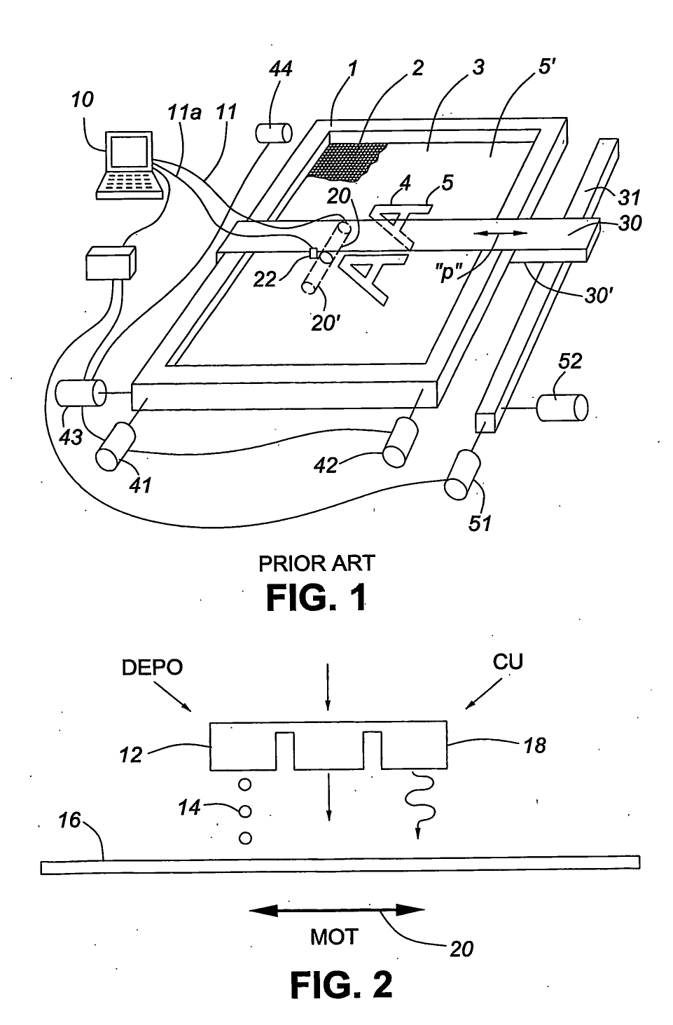

FIG. 1 illustrates a prior art method as described in aforementioned U.S. Pat. No. 5,875,712 in which an inkjet printer is used to deposit light blocking material onto an emulsion coated screen where the material prevents light from reaching the screen so that the unexposed emulsion underneath the blocking material can be washed away.

The present invention makes use of inlet printing technology in a computer to screen (CTS) imaging system. It is well known that digital imaging techniques can be used to store, in a computer, digital images of patterns which are to be reproduced on a silk screen or a lithography plate for generating a screen or plate. The concept is analogous to the production of a printed image on a sheet of paper wherein “ink” is ejected onto the paper as a reproduction of the image stored in the computer. In the present invention this technology is extended to depositing patterns onto a silk screen or lithographic plate using various techniques. In one embodiment the inkjet technology is combined with the continuing developments in the LED technology to produce the image. In a previous application (U.S. Provisional 60/304,073) an LED is used to create an image directly on the screen without the use of a photomask. In that application the screen is pre coated, exposed to the LED source and then developed (washed with water to remove the undeveloped emulsion) thus leaving the desired image. The previous technique is considered to be a wet and light activated stencil production. The contents of U.S. Provisional Application 60/304,073 is incorporated herein by reference.

The present invention relies on three basic principles.
1. The mobility of a liquid through a medium such as a dry emulsion is inversely proportional to the particle (solid) content 6f that liquid: The solid content will be highest nearest the point of injection. Filtration with a filter paper operates on this principle.
2. The ability to increase the solid concentration during the crosslinking process: The durability and the sharpness of an image on a screen stencil is dependent on its solid content. The greater the solid content the better these properties will be.
3. A strong correlation and the co-location of the solid manufacturing and the crosslinking processes: The solid is used as a lattice frame-work around which the water insoluble polymer is formed. Therefore it is highly advantageous to co-locate and encourage an inter-dependency of these processes.

If these three principles can be combined in a chemical curing agent that is used to prepare a screen stencil, it will produce a sharp, high resolution and durable image for the following reasons. The reduced mobility of the curing agent will reduce the tendency to defocus the image, principle (1). The increase in solid content will add toughness to the emulsion, principle (2). The colocation and strong correlation between the crosslinking process will bias the polymer formulation to areas where the solid concentration is highest, therefore the polymer will form preferentially at the point of injection, principle (3)

The conversion of a water soluble polymer to a water insoluble polymer is the goal of any screen stencil formation process. A redox reaction can be used to induce such a conversion. The oxidation of the ferrous ion (Fe²⁺) to the ferric ion (Fe²⁺) is but one example of such a reaction. This is demonstrated by using the following protocol. A screen was coated with a commercially available standard SBQ photopolymer screen emulsion using the accepted industry method. Examples of suitable SBQ photopolymer screen emulsions are Majestic 067 and Majestic 057. Solutions of 1:50 by weight of FeSO₄, CuSo₄, FeCl₂ and NaCl in water were deposited onto screens and left to dry in the dark in air and at room temperature. On subsequent immersion in water or by using the standard industrial procedure only those regions-that were covered by the ferrous ion, FeSO₄ or FeCl₂, were found to be insoluble in water. Moreover the screens could be reclaimed using the standard industrial method.

It is well known that in the presence of O₂ the ferrous ion is readily oxidized to the ferric ion via a redox reaction. The rest of this discussion will be focussed on the use of FeSO₄ to form a stencil and its relationship to the three principles just outlined. FeSO₄ is solid that is very soluble in water. However in the presence of oxygen it is readily converted to Fe₂O₃, a solid that is very insoluble in water. It is now apparent why FeSO₄ would represent an optimal chemical curing agent for a screen emulsion. Its high solubility in water allows for its effective and even dispersion in a water-soluble emulsion. As the emulsion dries the Fe²⁺ ion comes in contact with either dissolved O₂ or atmospheric oxygen. This occurrence readily promotes the redox reaction that converts Fe²⁺ to Fe³⁺. This reaction initiates crosslinking, and in the same location, concurrently forms the solid Fe₂O₃. This solid now becomes the lattice around which the insoluble polymer forms. Finally, the solid Fe₂O₃ partides inhibits the further spread of Fe₂SO₄ from the point of initial application thus maintaining the image resolution during the wetting process.

The previous discussion described how it is possible to manufacture a solid filler during the curing process. Given this, there are other novel variations on this generic theme. In the previous example a single chemical FeSO₄ could perform both function. It is possible that the use of a single chemical may not always be preferable.

The preferred curing agent may not lead to solid formation or the preferred solid may not initiate the curing process. If this is the case a variation on this theme can be implemented. It utilizes the fact that colour production using an inkjet involves co-locating the three primary colours magenta, cyan and yellow. Therefore the magenta and the yellow ink, for example, in a standard inkjet can be replaced with chemical A and B such that when they are combined an insoluble solid X is produced. At the same time a curing agent C placed in the cyan head can be co-located. The appropriate software could then be used to co-locate the appropriate amount of A, B and C in the appropriate concentrations such that as X is being generated by A and B, C concurrently cures the emulsion. As an example A could be Ca(HCO₃)₂ and B could be NaOH. These chemicals when combined produce the insoluble solid CaCO₃ and soluble Na(HCO₃) in solution. Any Na(HCO₃) that is not incorporated in the solid will be washed away during the wash out phase of making a stencil.

The curing agent C need not be a chemical. It could be photons. This is particularly advantageous since most screen emulsions are designed to be photo-activated with UV photons Therefore an array of UV LEDs or similar light sources could be used instead of C or in combination with C to drive the necessary crosslinking. The photons need not be UV. IR or Visible could also be used to photo activate the chemical curing agent C or photo activate the reaction between A and B. Alternatively, such photons could be used to determine the kinetics of C interacting with the polymer or A reacting with B by providing additional translation vibration or electronic energy.

Given that a method of dynamically integrating a chemical cure with a photon cure has been established, there may be some situations where it would be advantageous to intelligently and dynamically select between these methods on the same image for a given emulsion. It is not uncommon to have areas of high and low resolution in the same image. If one can intelligently and dynamically separate the areas of low and high resolution one can use the optimum curing source for that specific area of the image.

It is relatively simple and inexpensive to produce an inkjet head with 2400 dpi capability. This is a difficult and capital expensive task to do with LEDs. Conversely a chemical cure using an inkjet at high resolution could consume a large quantity of an expensive chemical, but once the LED head has been produced its operational cost is relatively inexpensive. Finally it is relatively simple to control the operational characteristics of a long (<100 cm) LED array head containing many thousands of LEDs. It is a non trivial problem to control the jetting characteristics of more than 500 nozzles simultaneously.

If the interchange between LEDs and inkjet cure can be performed dynamically, i.e. one can use the optimum curing agent for a prescribed portion of the image. The net effect of this will be a reduction in operational cost and an increase in processing speed whilst maintaining the desirable image quality. The costly chemical will only be used where it is needed and full advantage will be taken of the long LED array to rapidly cure the low resolution portions of the image.

As stated earlier CA 02088400 as described is not applicable to a standard screen emulsion with typical inkjets. Even if such jets were capable of jetting the very viscous material (10,000 cps) the nozzles will quickly become blocked by the high particle content of a standard emulsion. The application of principles 2 and 3 could be used to make the art described in CA 02088400 applicable to a screen emulsion formulation. As discussed previously the purpose of the solid is to provide a lattice framework around which the water insoluble polymer is formed. If principle 2 and 3 is applied to an emulsion which has had its solid removed before jetting, an equivalent solid will be manufactured during the curing process. The scientific basis for this was developed as follows.

A 3.1 mixture of a commercial SBQ photopolymer and water was prepared. This mixture was placed in a centrifuge for 15 minutes. The liquid and the solid separated into two distinctive components. The liquid was removed and passed through a 3 micron cellulose filter. Measurements with a particle size monitor confirmed that the maximum particle size in the filtered emulsion were less than 5 microns. This can be compared to average particulate sizes of greater than 40 microns in the standard formulation. This mixture was heated in a water bath to 90° C. At this temperature the measured viscosity was 4 cps. A mixture containing 1 part FeSO₄ (1:25, FeSO₄:H2O) to 1 part of C₂H₅OH was deposited in the form of a halftone image onto a screen coated with this hot mixture. It was left to dry in the dark in air and at room temperature. The screen was then developed as per the industry standard. There was no obvious difference between the stencil formed from this mixture and that formed from an unheated mixture.

A sample of SBQ photopolymer with no added solid filler was secured from a commercial supplier. A small quantity of a water base dye was added to this polymer to improve contrast for our experimental purposes. A screen was coated and dried in the usual manner. A mixture containing 1 part FeSO₄ (1:25, FeSO₄:H2O) to 1 part of C₂H₅OH was deposited in the form of a halftone image on the screen. It was left to dry in the dark in air and at room temperature. The screen was then developed as per industry standard. Again there was no obvious difference between the quality of this image and one produced by the filtered and heated emulsion.

As a final example 0.05 gms of FeSo₄ was dissolved directly in 10 gms of the photopolymer mix. Provided this mixture remained in the dark and not exposed to air it remained in a liquid state. If a screen was coated with this mixture and left to dry in the dark in the presence of air the “mixture” on the screen became insoluble in water. However the screen could be reclaimed as before.

It is clear from the foregoing that
1. A “solid free” or a low particle size emulsion can be formulated to meet the viscosity requirement of a typical inkjet.
2. This emulsion formulation is stable at the temperature needed to reduce its viscosity to a level compatible with the requirements of an ink jet.
3. This emulsion can be converted from water soluble to water insoluble.
4. This emulsion can be processes according to principle 2 and 3 to produce a stencil.
5. The curing agent can be added directly to the emulsion.

It must follow that if a solid free version of this emulsion is placed in one colour chamber of a typical inkjet it should be possible to co-locate this emulsion with a curing agent such as FeSO₄ that had been placed in a second chamber. The deposition can be made in an image wise manner and the solid will be produced in accordance with principles 2 and 3 during the curing process. This solid will form the lattice frame work for the water insoluble polymer. With this method a print ready stencil can be prepared on an uncoated screen from a standard emulsion.

Naturally all of the variations and combinations of photon and chemical cure that was previously described can be applied to this method. That is a combination of LEDs and inkjets can be used to manufacture the solid and supply the curing agent.

There is further possibility with this method. Provided FeSO₄ is in an oxygen free (or oxygen deficient) environment, formation of the ferric ion is inhibited. Therefore a mixture of the photopolymer and FeSO₄ is stable provided it is kept in a dark oxygen free (or oxygen deficient) environment. However if a drop of this mixture is placed on a surface and allowed to dry in atmospheric oxygen in the dark it will form a water insoluble polymer. The drying action of the emulsion will bring the FeSO₄ in contact with atmospheric oxygen and hence initiate the redox reaction. A sealed inkjet reservoir meets the requirement of being a dark oxygen free (or oxygen deficient) environment. Therefore an inkjet system could be used to deposit the mixture of FeSO₄ and photopolymer in the form of an image. This method can therefore prepare a print ready stencil on a blank screen in one step.

The terms curing and curing process for the sake of the present application include the process wherein a curing agent or curing agents creates, co-locates and incorporates additional and soluble particulate (strengthening agents) by the interaction of one or more elements either in combination or singularly with the blocking agent or in combination or singularly with themselves at the location where the blocking agent becomes water insoluble.

It is obvious that someone skilled in the art could combine any of the above proposals to produce a stencil production system that is either “dry” or “light free” or “wet” to meet the specific requirements of an emulsion type. Inkjets are now widely available for dispensing a variety of fluids. Therefore the above system could be configured to dispense inks (Magenta, Yellow and Green), emulsion and activators combinations and hence function as either a standard inkjet printer or a “Digital Stencil Printer”.

Naturally anyone skilled in the art would recognise that any light source with the equivalent properties of the LED arrays could be used to replace the LEDs. However the use of LEDs offer the following two advantages. It should be possible to co-locate the positions of inkjet spots and the LEDs position on the screen or plate and one could easily tune the spectral properties of the LEDs to optimise the curing process. In addition other emulsions and light free activators combination could be used.

FIG. 2 is a high level representation of a screen 16 which, depending on which of the above described embodiments is used, is coated with a water soluble blocking agent or is uncoated. A nozzle 12 such as an inkjet printer is used to selectively deposit the curing agent or agents. In the case of multiple agents the inkjet printer will comprise means to deliver the additional elements of the curing agent. Although the fluid delivery system is defined as being an inkjet it will be apparent to one skilled in the art that other delivery systems may be used in place of the inkjet printer. In FIG. 2 element 18 is an LED module or similar device used to provide the protons in the embodiments in which protons are used in the curing process. IR, visable or UV emitting LEDs can be used. Other light sources can also be used.

An arrangement such as shown in FIG. 1 is contemplated for the delivery of the curing agents selectively or spanning the entire screen.

In summary, the present invention provides methods of: preparing a stencil without pre or post processing; preparing a stencil which uses chemical to define image and light to fix image; preparing a stencil with an emulsion that contains no solid/filler; preparing an emulsion which uses/contains a jettable “solid/filler” or chemical which has the same effect as a “solid/filler”; preparing a stencil by using a redox polymerisation process to cure the emulsion; preparing a silk screen that does not need light to define image; preparing a stencil with a self curing emulsion; and preparing a stencil wherein the screen is re-claimable or re-usable.

Although particular embodiments of the invention have been described and illustrated it will be apparent to one skilled in the art that numerous changes can be made without departing from the basic concept. It is to be understood, however, that such changes will fall within the full scope of the invention as defined by the appended claims.

1.-41. (canceled)

42. A method of producing an image on a printing screen, comprising:
depositing an emulsion on the printing screen in an image-wise manner;
depositing a first agent with the emulsion, the first agent being a chemical in liquid solution and that forms solids upon reaction with a second agent;
providing the second agent to the deposited emulsion; and
providing a curing agent to the emulsion,
whereby the first agent forms solids within the emulsion upon reaction with the second agent, and whereby the emulsion cures about the solids so as to inhibit spread of the emulsion.

43. The method of claim 42 wherein the second agent is atmospheric oxygen, and wherein the first agent is maintained in an oxygen deficient environment until deposited with the emulsion.

44. The method of claim 43 wherein the first agent is FeSO₄.

45. The method of claim 43 wherein the first agent is pre-mixed in solution with the emulsion such that depositing the first agent occurs as part of depositing the emulsion.

46. The method of claim 45 wherein the first agent is FeSO₄.

47. The method of claim 42 wherein the second agent is a chemical in liquid solution, and wherein the method comprises the further step of depositing the second agent with the emulsion.

48. The method of claim 47 wherein the first agent is CaCl and the second agent is NaCO₃.

49. The method of claim 42 wherein the curing agent comprises photons emitted by a Light Emitting Diode.

50. The method of claim 42 wherein the emulsion is a diluted and filtered photopolymer.

51. The method of claim 50 wherein the emulsion and the first agent are each provided in a separate well of an inkjet cartridge, and wherein the emulsion and the first agent are deposited simultaneously using an inkjet printer.

52. The method of claim 51 wherein the emulsion and the first agent are deposited based on a computer-to-screen imaging system.

53. The method of claim 51 wherein the curing agent is a chemical in liquid solution, wherein the curing agent is provided in a separate well of the inkjet cartridge, and wherein providing the curing agent to the emulsion comprises depositing the curing agent using the inkjet printer simultaneously to depositing the emulsion.

54. The method of claim 51 wherein the second agent is atmospheric oxygen, and whereby the first agent forms insoluble agents upon deposition of the emulsion on the printing screen.

55. The method of claim 54 wherein the first agent if FeSO₄.

56. The method of claim 55 wherein the FeSO₄ and the atmospheric oxygen together act as the curing agent.

57. The method of claim 51 wherein the second agent is a chemical in liquid solution provided in a separate well of the inkjet cartridge, and wherein the method comprises the further step of depositing the second agent simultaneously with the emulsion.

58. The method of claim 57 wherein the first agent is CaCl and the second agent is NaCO₃.

59. The method of claim 51 wherein the curing agent comprises photons emitted by a Light Emitting Diode.
